(19) United States
(12) Patent Application Publication
(10) Pub. No.: US 2021/0232289 A1
(43) Pub. Date: Jul. 29, 2021

(54) VIRTUAL USER DETECTION

(71) Applicant: Ford Global Technologies, LLC, Dearborn, MI (US)

(72) Inventors: Turgay Isik Aslandere, Aachen (DE); Ke Fan, Würselen (DE); Frederik De Smet, Zonhoven (BE)

(73) Assignee: Ford Global Technologies, LLC, Dearborn, MI (US)

(21) Appl. No.: 17/149,035

(22) Filed: Jan. 14, 2021

(30) Foreign Application Priority Data
Jan. 24, 2020 (DE) 102020101746.4

(51) Int. Cl. G06F 3/0481; G06N 20/00; G06N 3/04; G06F 17/18

(52) U.S. Cl. CPC G06F 3/04815; G06F 17/18; G06N 3/04; G06N 20/00

(57) ABSTRACT

A plurality of training data sets of user interactions in a real environment can be determined. A machine learning program is trained with the training data sets. A data set of virtual user interactions with a virtual environment is input to the trained machine learning program to output a probability of selection of an object in the virtual environment. The object is identified in the virtual environment selected by a user based on the probability. A manipulation of the object by the user is then identified.

### CROSS-REFERENCE TO RELATED APPLICATIONS

This patent application claims priority to German Patent Application No. 102020101746.4, filed Jan. 24, 2020, which is hereby incorporated herein by its reference in its entirety.

### BACKGROUND

The representation and simultaneous perception of reality and its physical properties in an interactive virtual environment computer-generated in real time is referred to as virtual reality, abbreviated to VR.

The virtual environment is provided by a real-time rendering engine, which uses a rendering approach based on rasterization (depth buffer) such as OpenGL® or an approach based on ray tracing to create the virtual environment. This can be embedded, for example, in a game engine such as Unity3d or Unreal®.

The virtual environment can be visualized to a user using various display systems, for example Head Mounted Displays (HMD) or projection-based systems (for example CAVEs). Depending on the visual output, the virtual environment can be produced in various computer environments (GPU cluster, single workstation having multiple GPUs, or a laptop). In parallel, tracking data are acquired from body parts of a user, such as his head and/or his hands or fingers, for example by an infrared tracking system such as Leap Motion®, HTC Vive® sensors, or Intel RealSense®. The tracking data can comprise the position of the user and his body parts.

Marking-free finger tracking is possible using such an infrared tracking system, so that the user does not have to wear additional hardware, for example a data glove.

User interactions of a user with virtual objects in the virtual environment are necessary if not all objects can be represented by a mockup. One of the most common and natural methods for user interaction with the virtual objects is the virtual hand metaphor. However, user interactions of a user with the virtual objects in the virtual environment which use the virtual hand metaphor are difficult, in particular if traffic situations are simulated in the virtual environment. This is because the virtual objects are usually not represented using a physical object or mockup, and therefore the virtual environment lacks natural feedback and restricted vision. Known methods for user interaction do not offer very accurate interactions, however.

A method for user interaction acquisition of a user in a virtual environment is known from US 2017 0161555 A1, in which a recurrent neural network is used which was trained using training data sets representative of user interactions of the user in a real environment.

Further methods for user interaction acquisition of a user in a virtual environment are known from CN 109 766 795 A and U.S. Pat. No. 10,482,575 B2.

There is a demand for showing ways in which a user interaction of a user in a virtual environment can be improved.

### SUMMARY

Presently disclosed is a method for user interaction acquisition of a user in a virtual environment. Further disclosed is a computer program product and a system for such a user interaction acquisition.

The method for user interaction acquisition of a user in a virtual environment can include the following steps:
reading in a plurality of training data sets representative of user interactions of the user in a real environment,
training an artificial neural network using the training data sets,
applying a user data set representative of a user interaction of the user in the virtual environment to the trained artificial neural network in order to determine a value indicative of a probability of a selected object in the virtual environment,
determining an object selected by the user interaction in the virtual environment by evaluating at least the value indicative of a probability, and
determining a manipulation of the object by the user.

In other words, a trained artificial neural network is used which was trained in a preceding training phase using training data sets obtained in a real environment. In an example, the trained artificial neural network provides a value indicative of a probability of a selection of an object in the virtual environment by the user. The actual determination of the selected object first takes place in a further step by evaluation of the value for the probability. A manipulation of the object by the user then takes place in a further step. The trained artificial neural network is thus used to carry out a determination of a selected object beforehand, before a manipulation of the object by the user is acquired. By inserting intermediate steps, which incorporate a trained artificial neural network into the method, a user interaction acquisition of a user in a virtual environment is thus improved.

For example, a recurrent neural network is used as the artificial neural network. Recurrent or feedback neural networks are understood as neural networks which, in contrast to feedforward networks, are distinguished by connections of neurons of one layer to neurons of the same or a preceding layer. Examples of such recurrent neural networks are the Elman network, the Jordan network, the Hopfield network, and also the completely interconnected neural network and the LSTMs (long short-term memory). Using such recurrent neural networks, sequences can be evaluated particularly well, such as movement sequences of gestures, for example hand movements of a user.

In another example, the plurality of training data sets are trajectory data indicative of head and/or hand positions and/or orientations. Head positions and orientations are considered to be indicative of a viewing direction of the user in this case. The head positions and orientations can be acquired using an HMI, which is designed, for example, as a virtual reality headset. In contrast, the hand positions and/or orientations are considered to be indicative of gestures, for example grasping movements or touching processes to actuate switches or buttons. The hand positions and/or orientations can be acquired, for example using an infrared tracking system, which moreover enables marking-free finger tracking. In particular a combined evaluation of viewing direction and gestures of a user permits particularly reliable determination of a selected object.

In another example, the value indicative of a probability is compared to a threshold value and the object is selected if the value indicative of a probability is greater than the threshold value. In other words, a threshold value comparison is carried out. Only the objects are determined as selected objects for which an increased probability of, for example 0.8 or 0.9 is actually given. The reliability of the method is thus increased.

In another example, at least one value indicative of a probability of a first object is compared to a value indicative of a probability of a second object, and the object having the higher value is selected. In other words, two probability values are compared, which are associated with different objects. The reliability of the method can thus also be increased.

In another example, a plurality of user data sets each having a predetermined duration are formed from sensor data indicative of a user interaction of the user. In other words, the sensor data represent a data stream which contains, for example data indicative of the head and/or hand positions and/or orientations of the user. This data stream is divided into user data sets, which are representative of the movement sequences which comprise, for example, gestures of the user. The predetermined duration can have a fixed value, or the sensor data are evaluated beforehand to determine a beginning and an end of a possible gesture, so that the predetermined duration then has a value adapted in each case. The reliability of the method can thus be increased.

Further disclosed is a computer program product and a system for such a user interaction acquisition.

### BRIEF DESCRIPTION OF THE DRAWINGS

FIG. 1 shows a schematic illustration of a user of a virtual environment and components of the virtual environment.

FIG. 2 shows a schematic illustration of a training process and an evaluation process of a system for user interaction acquisition of a user in the virtual environment.

FIG. 3 shows a schematic illustration of further details of the training process and the evaluation process.

FIG. 4 shows a schematic illustration of a method sequence for operation of the system shown in FIG. 2.

### DETAILED DESCRIPTION

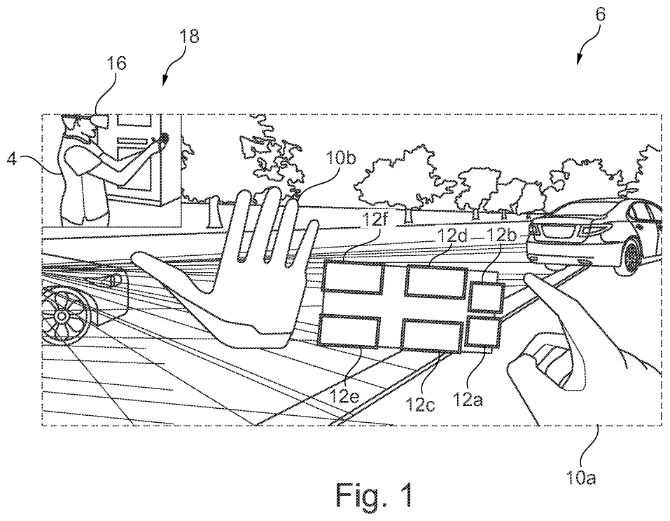

Reference is firstly made to FIG. 1.

A virtual environment 6 is shown, in which a user 4 executes a user interaction.

The representation and simultaneous perception of reality and its physical properties in an interactive virtual environment computer-generated in real time is referred to as virtual reality, abbreviated to VR.

Furthermore, software developed especially for this purpose is required for generating a virtual environment. The software has to be able to calculate complex three-dimensional values in real time, i.e. at at least 25 images per second, separately in stereo for the left and right eye of the user 8. This value varies depending on the application—a driving simulation, for example, requires at least 60 images per second to avoid nausea (simulator sickness).

To create a feeling of immersion, special HMIs 16, for example virtual reality headsets which the user 4 wears on his head, are used to display the virtual environment. To give a three-dimensional impression, two images are generated from different perspectives and displayed (stereo projection).

For a user interaction with the virtual world, tracking data are acquired from body parts of the user 4, such as his head and/or his hands or fingers, by a tracking system 18, e.g., an infrared tracking system such as Leap Motion®, HTC Vive® sensors, or Intel RealSense®.

The user interaction involves, for example, the selection and actuation of a selected object 12a, 12b, 12c, 12d, 12e, 12f in the virtual environment 6 by means of hand metaphors 10a, 10b represented in the virtual environment. The selection and actuation relates to the selection and actuation of objects 12a, 12b, 12c, 12d, 12e, 12f formed as buttons in the virtual environment 6 by means of the hand metaphors 10a, 10b by the user 4. In the scenario illustrated in FIG. 1, the user 4 wishes to select the object 12b in order to actuate it. In an example, it is for all objects 12a, 12b, 12c, 12d, 12e, 12f, whether they are the object 12b selected by the user 4. However, it can also be provided that a preselection is made from the entirety of the objects 12a, 12b, 12c, 12d, 12e, 12f. For example, the objects 12a, 12b can be selected in the context of the preselection.

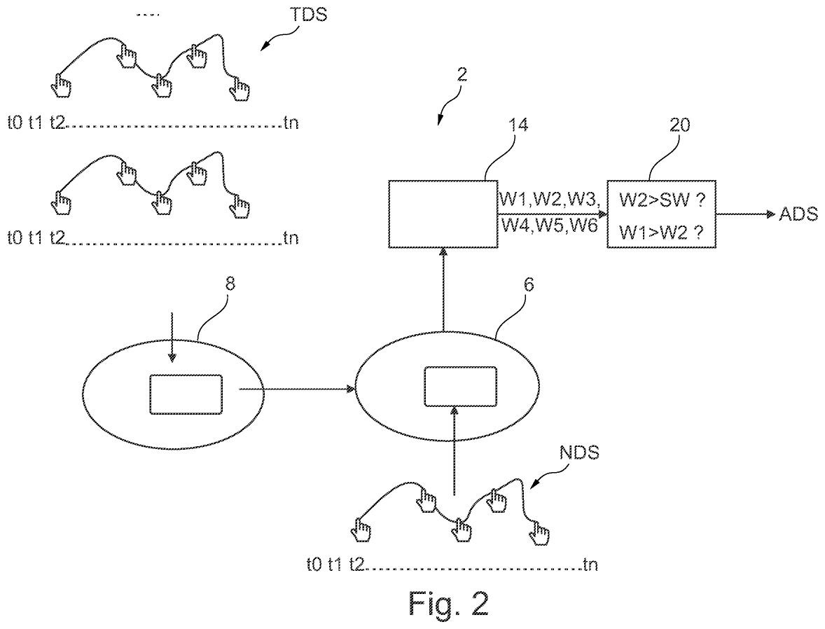

A system 2 for the user interaction acquisition of a user 4 in the virtual environment 6 will now be explained with additional reference to FIG. 2. The system 2 and its components described hereinafter can have hardware and/or software components which are designed for the respective tasks and/or functions.

The system 2 is designed for machine learning, as will be explained in greater detail hereinafter. For this purpose, the system 2 is designed to read in a plurality of training data sets TDS. The training data sets TDS are obtained by acquiring data representative of user interactions of the user 4 in a real environment 8. In other words, the data are recorded when the user actuates, for example, a real button.

In an example, the training data sets TDS contain data which are indicative of head and/or hand positions and/or orientations at various times t0, t1, t2, . . . tn of a movement sequence of the user 4. The head positions and orientations can be acquired using the HMI 16, which is designed, for example as a virtual reality headset, while the hand positions and/or orientations are acquired using a tracking system 18.

An artificial neural network 14 is trained using the training data sets TDS during a training phase to be able to determine a selected object 12a, 12b, 12c, 12d, 12e, 12f. Later in operation during an evaluation process, a user data set NDS representative of a user interaction of the user 4 in the virtual environment 6 is applied to the trained artificial neural network 14.

The user data set NDS contains, like the training data sets TDS, data which are indicative of head and/or hand positions and/or orientations at various times t0, t1, t2, . . . tn of a movement sequence of the user 4. The head positions and orientations can also be acquired using the HMI 16, which is designed, for example as a virtual reality headset, while the hand positions and/or orientations are also acquired using the tracking system 18.

The trained artificial neural network 14 provides a value W1, W2, W3, W4, W5, W6 as an output upon application of the user data set NDS, which is indicative of a respective probability for a selected object 12a, 12b, 12c, 12d, 12e, 12f. For example, the artificial neural network 14 is a recurrent neural network. Furthermore, the artificial neural network 14 has, for example, a many-to-one architecture, i.e. the artificial neural network 14 has a plurality of inputs, but only one single output.

Furthermore, the system 2 is designed to evaluate the value W1, W2, W3, W4, W5, W6 indicative of a probability in order to determine an object 12a, 12b selected by the user interaction in the virtual environment 6.

For this purpose, the system 2 can be designed to compare, for example, the value W2 indicative of a probability to a threshold value SW in an evaluation unit 20 and to select the object 12b if the value W2 indicative of a probability is greater than the threshold value SW.

Alternatively or additionally, the system 2 can be designed to carry out a selection from two objects 12a, 12b in the evaluation unit 20. For this purpose, the system 2 can determine a value W1 indicative of a probability of a first object 12a and a value W2 indicative of a probability of a second object 12b, compare the two values W1, W2 to one another, and select the object 12a, 12b having the higher value W1, W2.

In both cases, the system 2 or the evaluation unit 20 provides an output data set ADS, which identifies the selected object 12a, 12b, 12c, 12d, 12e, 12f.

Furthermore, the system 2 is designed to determine a manipulation of the determined object 12a, 12b, 12c, 12d, 12e, 12f by the user 4. Algorithms can be used for this purpose which are based on a collision determination of objects in the virtual environment 4 or on gesture recognition. The user 4 can operate additional input devices (not shown) for manipulation of the determined object 12a, 12b, 12c, 12d, 12e, 12f, e.g. a 3D mouse, a joystick, or a flystick.

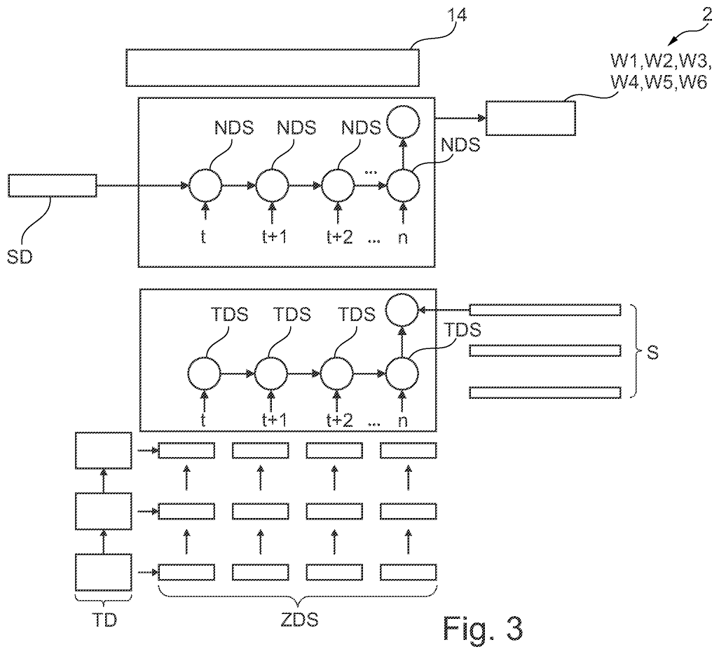

Further details of the system 2 shown in FIG. 2 will now be explained with additional reference to FIG. 3.

To train the artificial neural network 14, head and/or hand positions and/or orientations are acquired using the HMI 16 or the tracking system 18 in the form of trajectory data TS. The trajectory data TD are data streams. The trajectory data TD are converted by the system 2 into intermediate data sets ZDS for various times t0, t1, t2, . . . to of a movement sequence of the user 4 and then converted into the training data sets TDS, which each have a predetermined duration.

An item of status information S is also associated with each training data set TDS, about which object 12a, 12b, 12c, 12d, 12e, 12f was selected and/or whether it was not selected by the user 4 in the real environment 8. In other words, the artificial neural network 14 is trained by means of supervised learning.

After the training of the artificial neural network 14 during the training phase, later in operation during an evaluation process, the sensor data SD are similarly acquired using the HMI 16 and/or the tracking system 18 head and/or hand positions and/or orientations. Furthermore, the sensor data SD in the form of a data stream are converted by the system 2 into the user data sets NDS, which each have a predetermined duration.

As already mentioned, the trained artificial neural network 14 provides a value W1, W2, W3, W4, W5, W6 as an output upon application of the user data set NDS, which is indicative of a probability for a selected object 12.

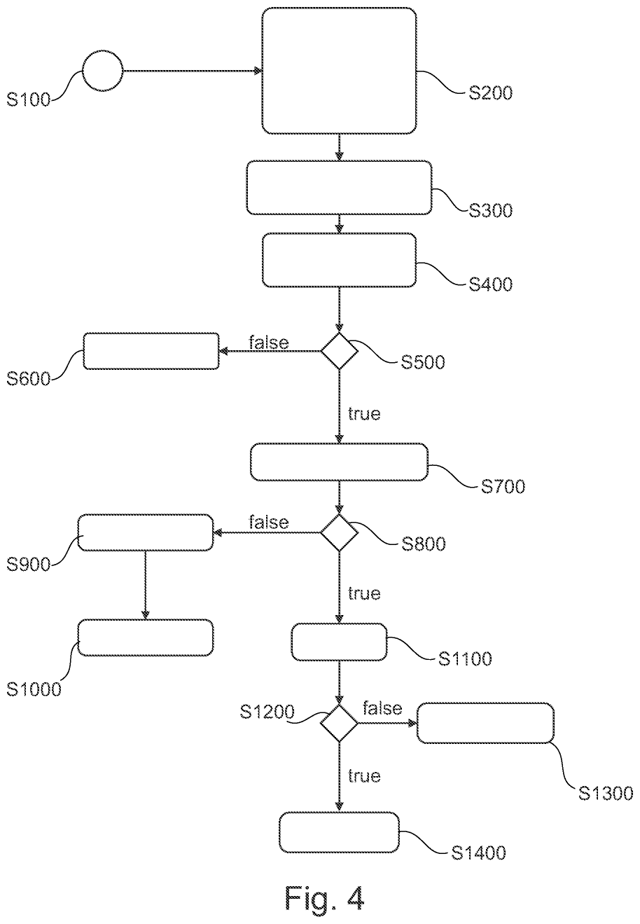

A method sequence for operating the system 2 having an already trained artificial neural network 14 is now explained with additional reference to FIG. 4.

The method starts with a first step S100.

In a further step S200, the system 2 reads in the user data set NDS.

In a further step S300, the user data set NDS is applied to the trained artificial neural network 14 and it supplies the value W1, W2, W3, W4, W5, W6 indicative of a probability for the respective selected object 12a, 12b, 12c, 12d, 12e, 12f.

In a further step S400, the system 2 compares, for example, the value W2 to a predetermined threshold value SW. If the value W2 is less than the threshold value SW (false), the method is continued with a further step S600 to then be started again with first step S100. In contrast, if the value W2 is greater than or equal to the threshold value (true), the method is continued with a further step S700.

It is to be noted that notwithstanding the present example, alternatively or additionally to the described threshold value comparison, two values W1, W2, which are associated with two objects 12a, 12b, can be compared.

In other words, the virtual environment 4 is cyclically searched for objects 12a, 12b, 12c, 12d, 12e, 12f at a predetermined periodic duration or duration of, for example 3 seconds, which could be the subject of a user interaction. In the context of this search, the sensor data SD were previously divided into the plurality of user data sets NDS. If a plurality of objects 12a, 12b, 12c, 12d, 12e, 12f are located in the virtual environment 4, it can be provided that the number of the objects 12a, 12b, 12c, 12d, 12e, 12f is reduced by a minimum bounding box algorithm, for example to the two objects 12a, 12b. The demand for computer resources can thus be reduced.

In a further step S700, the selection of the object 12a, 12b, 12c, 12d, 12e, 12f is then confirmed, for example by the user 14. However, if the object 12a, 12b, 12c, 12d, 12e, 12f is not the object 12a, 12b, 12c, 12d, 12e, 12f selected by the user 14 (false), the method is continued with a further step S900, in order to then enable a further selection and be started again with first step S100. In contrast, if the object 12a, 12b, 12c, 12d, 12e, 12f is the object 12a, 12b, 12c, 12d, 12e, 12f selected by the user 14 (true), the method is continued with a further step S1100.

In further step S1100, the actual manipulation of the object 12a, 12b, 12c, 12d, 12e, 12f by the user 4 in the virtual environment 6 then takes place, such as an actuation of a button.

If direct manipulation of the object 12a, 12b, 12c, 12d, 12e, 12f by the user 4 cannot be acquired by the system 2 (false), the method is continued with a further step S1300.

In step S1300, a gesture recognition is carried out to detect a direct manipulation of the object 12a, 12b, 12c, 12d, 12e, 12f by the user 4.

In contrast, if direct manipulation of the object 12a, 12b, 12c, 12d, 12e, 12f by the user 4 can be detected (true), the method is continued with a further step S1400.

In step S1400, the direct manipulation of the object 12a, 12b, 12c, 12d, 12e, 12f by the user 4 is implemented.

Notwithstanding the present examples, the sequence of the steps can also be different. Furthermore, multiple steps can also be executed at the same time or simultaneously. Furthermore, notwithstanding the present examples, individual steps can also be skipped or omitted.

By inserting intermediate steps which incorporate the trained artificial network 14 into the method, a user interaction acquisition of a user 4 in a virtual environment 6 can thus be improved.

### LIST OF REFERENCE SIGNS

2 system
4 user
6 virtual environment
8 real environment
10a hand metaphor
10b hand metaphor
12a object
12b object
12c object
12d object
12e object
12f object
14 artificial neural network
16 HMI
18 tracking system
20 evaluation unit
ADS output data set
NDS user data set
S status information
SD sensor data
SW threshold value
t0 time
t1 time
t2 time
to time
TD trajectory data
TDS training data set
W1 value
W2 value
W3 value
W4 value
W5 value
W6 value
ZDS intermediate data sets
S100 step
S200 step
S300 step
S400 step
S500 step
S600 step
S700 step
S800 step
S900 step
S1000 step
S1100 step
S1200 step
S1300 step
S1400 step

1.-13. (canceled)

14. A system, comprising a computer including a processor and a memory, the memory storing instructions executable by the processor to:
determine a plurality of training data sets of user interactions in a real environment;
train a machine learning program with the training data sets;
input a data set of virtual user interactions with a virtual environment to the trained machine learning program to output a probability of selection of an object in the virtual environment;
identify the object in the virtual environment selected by a user based on the probability; and
identify a manipulation of the object by the user.

15. The system of claim 14, wherein the machine learning program is a recurrent neural network.

16. The system of claim 14, wherein the plurality of training data sets include trajectory data of at least one of head positions, hand positions, head orientations, or hand orientations.

17. The system of claim 14, wherein the instructions further include instructions to identify the object when the probability exceeds a threshold.

18. The system of claim 14, wherein the instructions further include instructions to determine a probability of selection of a second object and to identify the second object when the probability of selection of the second object exceeds the probability of selection of the object.

19. The system of claim 14, wherein the instructions further include instructions to generate a plurality of sets of sensor data of user interactions, each set including data for a respective period of time different than the period of time for each other data set.

20. The system of claim 14, wherein the instructions further include instructions to actuate an input device based on the identified manipulation of the object.

21. The system of claim 14, wherein the instructions further include instructions to determine the plurality of training data sets of user interactions based on data from a virtual reality headset.

22. The system of claim 14, wherein the instructions further include instructions to determine the plurality of training data sets of user interactions based on data from an infrared tracking sensor.

23. The system of claim 14, wherein the instructions further include instructions to determine the data set of virtual user interactions with the virtual environment based on data from a virtual reality headset.

24. A method, comprising:
determining a plurality of training data sets of user interactions in a real environment;
training a machine learning program with the training data sets;
inputting a data set of virtual user interactions with a virtual environment to the trained machine learning program to output a probability of selection of an object in the virtual environment;
identifying the object in the virtual environment selected by a user based on the probability; and
identifying a manipulation of the object by the user.

25. The method of claim 24, wherein the machine learning program is a recurrent neural network.

26. The method of claim 24, wherein the plurality of training data sets include trajectory data of at least one of head positions, hand positions, head orientations, or hand orientations.

27. The method of claim 24, further comprising identifying the object when the probability exceeds a threshold.

28. The method of claim 24, further comprising determining a probability of selection of a second object and identifying the second object when the probability of selection of the second object exceeds the probability of selection of the object.

29. The method of claim 24, further comprising generating a plurality of sets of sensor data of user interactions, each set including data for a respective period of time different than the period of time for each other data set.

30. The method of claim 24, further comprising actuating an input device based on the identified manipulation of the object.

31. The method of claim 24, further comprising determining the plurality of training data sets of user interactions based on data from a virtual reality headset.

32. The method of claim 24, further comprising determining the plurality of training data sets of user interactions based on data from an infrared tracking sensor.

33. The method of claim 24, further comprising determining the data set of virtual user interactions with the virtual environment based on data from a virtual reality headset.
